(19) United States
(12) Patent Application Publication
(10) Pub. No.: US 2006/0129726 A1
(43) Pub. Date: Jun. 15, 2006

(54) Methods and apparatus for processing a command

(75) Inventors: Wayne M. Barrett, Rochester, MN (US); Brian T. Vanderpool, Byron, MN (US)

Correspondence Address: Robert Williams;IBM Corporation, Intellectual Property Law Dept. 917, 3605 Hwy. 52 North, Rochester, MN, 55901, US

(73) Assignee: International Business Machines Corporation, Armonk, NY (US)

(21) Appl. No.: 11/008,813

(22) Filed: Dec. 9, 2004

(51) Int. Cl. G06F 13/00

(52) U.S. Cl. 710/107

(57) ABSTRACT

In a first aspect, a first method is provided for processing commands on a bus. The first method includes the steps of (1) in a first phase of bus command processing, receiving a new command from a processor in a memory controller via the bus, wherein a command on the bus is processed in a plurality of sequential phases; (2) starting to perform memory controller tasks the results of which are required by a second phase of bus command processing; (3) before performing the second phase of bus command processing on the new command, determining whether there are any pending commands previously received in the memory controller that should complete before the second phase of processing is performed on the new command; and (4) if not, performing the second phase of processing on the new command without requiring the memory controller to insert a processing delay on the bus. Numerous other aspects are provided.

### FIELD OF THE INVENTION

The present invention relates generally to processors, and more particularly to methods and apparatus for processing a command.

### BACKGROUND

During conventional processing of commands on a bus, a second phase of processing may not commence until a memory controller completes tasks, the results of which are required by the second phase. If the memory controller does not complete such tasks within an allotted time, the memory controller may insert a delay (e.g., stall) on the bus such that the memory controller may complete the tasks. Such delays increase command processing latency. Consequently, improved methods and apparatus for processing a command would be desirable.

### SUMMARY OF THE INVENTION

In a first aspect of the invention, a first method is provided for processing commands on a bus. The first method includes the steps of (1) in a first phase of bus command processing, receiving a new command from a processor in a memory controller via the bus, wherein a command on the bus is processed in a plurality of sequential phases; (2) starting to perform memory controller tasks the results of which are required by a second phase of bus command processing; (3) before performing the second phase of bus command processing on the new command, determining whether there are any pending commands previously received in the memory controller that should complete before the second phase of processing is performed on the new command; and (4) if there are no pending commands previously received in the memory controller that should complete before the second phase of processing is performed on the new command, performing the second phase of processing on the new command without requiring the memory controller to insert a processing delay on the bus.

In a second aspect of the invention, a first apparatus is provided for processing commands on a bus. The first apparatus includes (1) a plurality of processors for issuing commands; (2) a memory; (3) a memory controller, coupled to the memory, for providing memory access to a command; and (4) a bus, coupled to the plurality of processors and memory controller, for processing the command. The apparatus is adapted to (a) in a first phase of bus command processing, receive a new command from a processor in the memory controller via the bus, wherein a command on the bus is processed in a plurality of sequential phases; (b) start to perform memory controller tasks the results of which are required by a second phase of bus command processing; (c) before performing the second phase of bus command processing on the new command, determine whether there are any pending commands previously received in the memory controller that should complete before the second phase of processing is performed on the new command; and (d) if there are no pending commands previously received in the memory controller that should complete before the second phase of processing is performed on the new command, perform the second phase of processing on the new command without requiring the memory controller to insert a processing delay on the bus. Numerous other aspects are provided in accordance with these and other aspects of the invention.

Other features and aspects of the present invention will become more fully apparent from the following detailed description, the appended claims and the accompanying drawings.

### BRIEF DESCRIPTION OF THE FIGURES

FIG. 1 is a block diagram of a first exemplary apparatus for processing commands in accordance with an embodiment of the present invention.

FIG. 2 is a block diagram of a second exemplary apparatus for processing commands in accordance with an embodiment of the present invention.

FIG. 3 is a block diagram of a third exemplary apparatus for processing commands in accordance with an embodiment of the present invention.

FIG. 4 illustrates an exemplary method for processing commands in accordance with an embodiment of the present invention.

### DETAILED DESCRIPTION

The present invention provides methods and apparatus for processing a command. More specifically, according to the present methods and apparatus, a number of delays inserted on a bus by a memory controller during command processing is reduced, and consequently, command processing latency is reduced and system performance is increased. For example, while processing a command, rather than inserting a processing delay on the bus if the memory controller does not complete tasks within an allotted time, the present methods and apparatus employ a heuristic, which may complete within the allotted time, to determine whether the memory controller inserts a processing delay on the bus while processing the command.

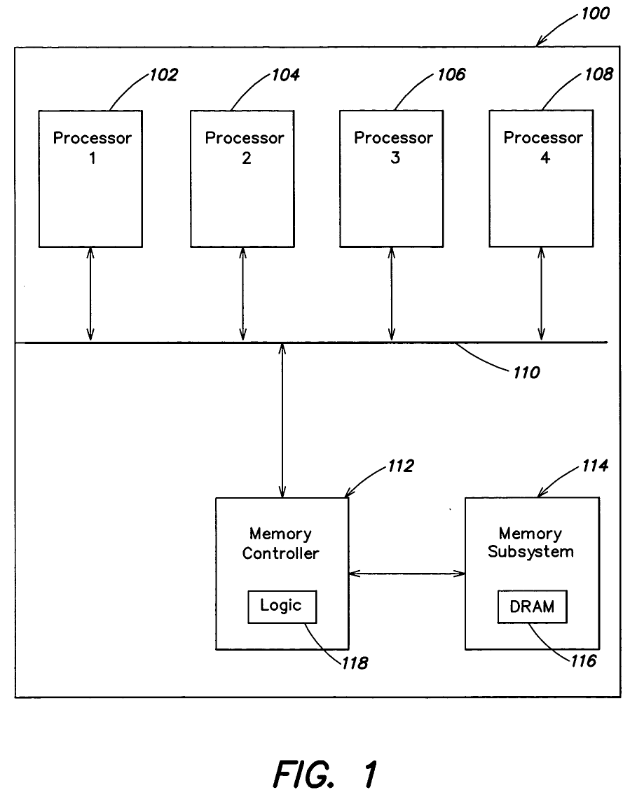

FIG. 1 is a block diagram of a first exemplary apparatus for processing commands in accordance with an embodiment of the present invention. With reference to FIG. 1, the first exemplary apparatus 100 may be a computer system or similar device. The apparatus 100 includes a plurality of processors 102-108 coupled to a bus 110, such as a processor bus (e.g., an Intel processor bus). In one embodiment, the apparatus includes four processors 102-108 and one bus (although a larger or smaller number of processors 102-108 and/or larger number of busses may be employed). Each of the plurality of processors 102-108 may issue one or more portions of a command on the bus 110 for processing.

The first exemplary apparatus 100 includes a memory controller (e.g., chipset) 112 which is coupled to the bus 110 and a memory subsystem 114 that includes one or more memories (e.g., DRAMs, cache, or the like) 116 (only one memory shown). The memory controller 112 is adapted to provide memory access to commands issued on the bus 110. The memory controller 112 includes logic 118 for (1) storing pending commands (e.g., in a queue or similar storage area); (2) identifying pending commands, which are accessing or need to access a memory address, that should complete before a new command that requires access to the same memory address may proceed; and/or (3) identifying a new command received in the memory controller 112 as colliding with (e.g., requiring access to the same memory address as) a pending command previously received in the memory controller 112 that should complete before a second phase of processing is performed on the new command. As described below, the apparatus 100 is adapted to reduce a total number of stalls inserted on the bus 110 by the memory controller 112 (e.g., during a second phase) while processing commands. Processing of commands issued on the bus 110 is performed in a plurality of sequential phases. For example, in a first phase (e.g., request phase) of command processing, a processor 102-108 may issue a command on the bus 110 such that the command may be observed by components coupled to the bus 110, such as remaining processors 102-108 and/or the memory controller 112. In a second phase (e.g., snoop phase) of command processing, results of tasks started by components of the apparatus 100 before the second phase that are required by the second phase are presented. In a third phase (e.g., response phase) of command processing, the memory controller 112 indicates whether a command is to be retried (e.g., reissued) or if data requested by the command will be provided. In a fourth phase (e.g., deferred phase) of command processing, if it is determined in the response phase that data will be returned to the processor which issued the command, the memory controller 112 may return such data.

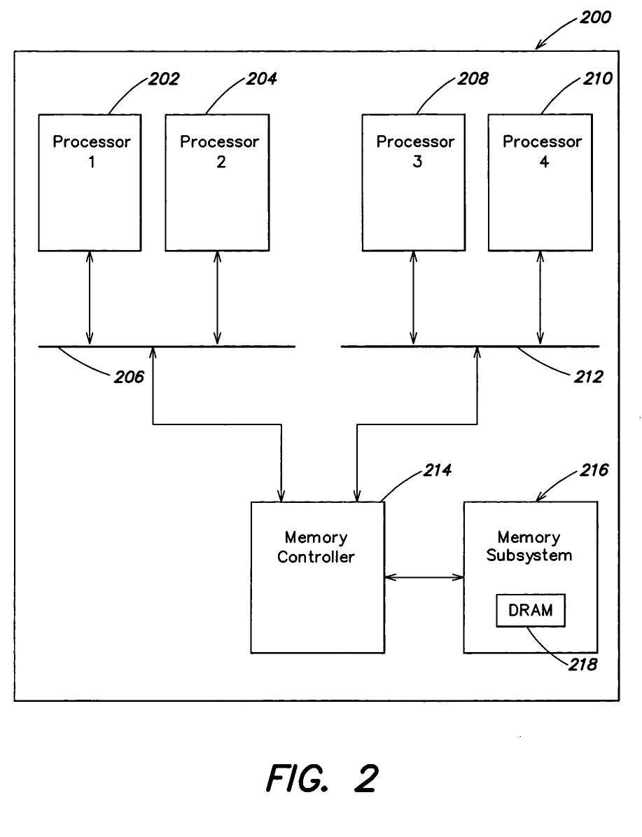

FIG. 2 is a block diagram of a second exemplary apparatus for processing commands in accordance with an embodiment of the present invention. With reference to FIG. 2, the second exemplary apparatus 200 for processing commands is similar to the first exemplary apparatus 100 for processing commands. In contrast to the first exemplary apparatus 100 for processing commands, the second exemplary apparatus 200 includes a plurality of busses for coupling processors to a memory controller. More specifically, the second exemplary apparatus 200 includes one or more processors 202-204 coupled to a first bus 206 (e.g., processor bus). Similarly, the second exemplary apparatus 200 includes one or more processors 208-210 coupled to a second bus 212. The first 206 and second busses 212 are coupled to a memory controller 214 which is coupled to a memory subsystem 216 that includes one or more memories 218. The memory controller 214 and memory subsystem 216 of the second exemplary apparatus 200 are similar to the memory controller 112 and memory subsystem 114, respectively, of the first exemplary apparatus 100. In this manner, the memory controller 216 may provide memory access to commands issued on the first 206 and/or second bus 212.

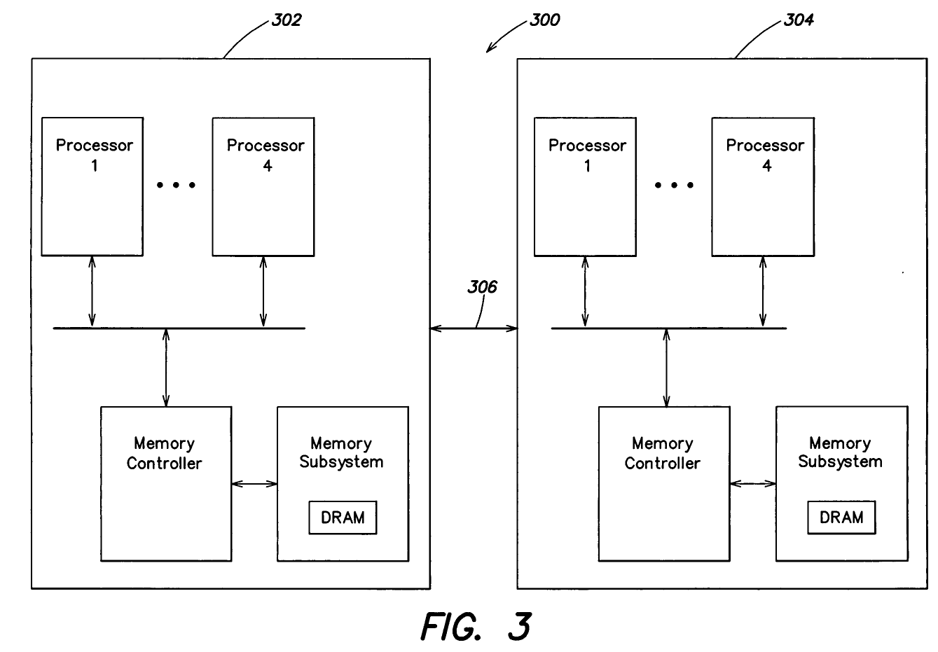

FIG. 3 is a block diagram of a third exemplary apparatus for processing commands in accordance with an embodiment of the present invention. With reference to FIG. 3, the third exemplary apparatus 300 may include a first apparatus 302 for processing commands coupled to a second apparatus 304 for processing commands via scalability network 306. More specifically, the scalability network 306 may couple respective memory controllers in the first 302 and second apparatus 304 (although the scalability network 306 may couple other components of the first 302 and second apparatus 304). In one embodiment, the first 302 and second apparatus 304 may be similar to the first exemplary apparatus 100 for processing commands. In this manner, a memory controller of the first apparatus 302 may provide memory access to commands issued by processors on a bus of either the first 302 and/or second apparatus 304. Similarly, a memory controller of the second apparatus 304 may provide memory access to commands issued by processors on a bus of either the second 304 and/or first apparatus 302.

The configuration of the third exemplary apparatus 300 for processing commands may be different. For example, the third exemplary apparatus 300 may include a larger number of apparatus coupled via the scalability network 306. Further, each apparatus coupled to the scalability network 306 may include a larger or smaller number of processors and/or a larger number of busses.

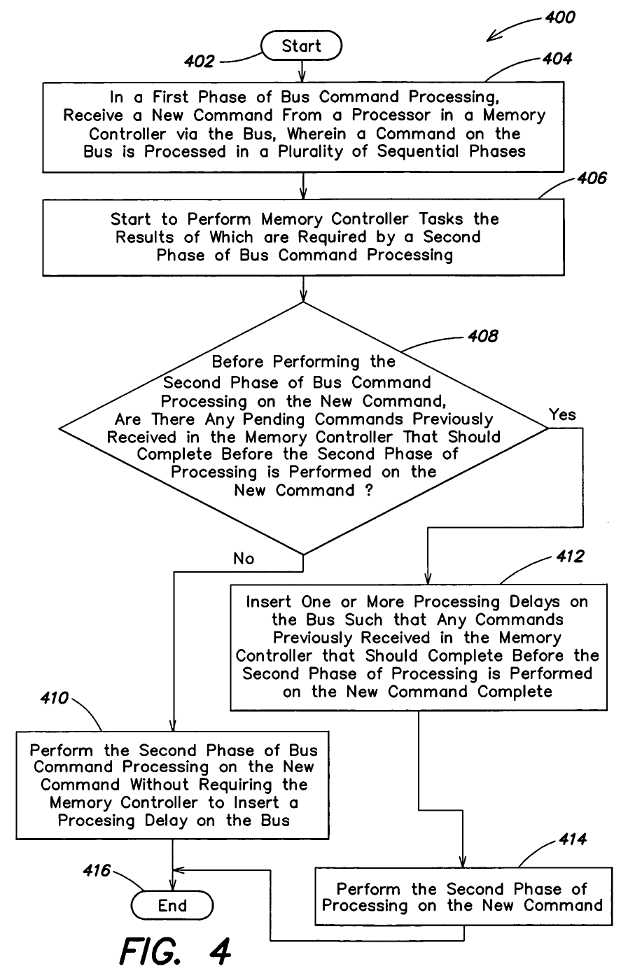

The operation of the first 100 exemplary apparatus for processing commands is now described with reference to FIG. 1 and with reference to FIG. 4 which illustrates an exemplary method for processing commands in accordance with an embodiment of the present invention. Although the exemplary method for processing commands is described below with reference to FIG. 1, the method may be performed by the second 200 and/or third exemplary apparatus 300 for processing commands in a similar manner. With reference to FIG. 4, in step 402, the method 400 begins. In step 404, in a first phase of bus command processing, a new command from a processor 102-108 is received in a memory controller 112 via the bus 110. As described above, a command on the bus 110 is processed in a plurality of sequential phases. For example, during a first phase of bus command processing, one of the plurality of processors 102-108 may issue a command on the bus 110. The command may be observed on the bus 110 by remaining processors 102-108 and the memory controller 112. The memory controller 112 may receive and store the command in a storage area (e.g., queue) for processing.

In step 406, performance of memory controller tasks the results of which are required by a second phase of bus command processing is started. More specifically, the memory controller 112 may perform calculations to determine whether the new command collides with another command (e.g., pending command), consolidate the calculations and notify the processor 102-108 issuing the command if the memory controller 112 wants the processor 102-108 to retry the command. In conventional apparatus for processing commands, if a memory controller is unable to complete such tasks before the second phase of bus command processing, the memory controller inserts a delay (e.g., stall) on the bus, thereby delaying the start of the second phase. Because the conventional apparatus for processing commands does not complete the tasks before the second phase of bus command processing, the memory controller inserts a delay (e.g., stall) on the bus for all (or nearly all) commands, thereby increasing command processing latency. In contrast, according to the present methods and apparatus, the memory controller 112 may avoid having to insert a delay (e.g., stall) on the bus 110 for all (or nearly all) commands.

More specifically, in step 408, before performing the second phase of bus command processing on the new command, it is determined whether there are any pending commands previously received in the memory controller that should complete before the second phase of processing is performed on the new command. For example, logic 118 included in the memory controller 112 may determine whether any pending previously-received commands which are stored in the memory controller storage area (e.g., queue) require access to the same memory location (e.g., cache entry) required to process the new command received in the memory controller 112. The memory controller 112 may access fields associated with each command to make such determination.

For each pending command previously received by the memory controller 112 that requires access to the same memory location (e.g., cache entry) as the new command, the memory controller 112 determines whether such command should complete before the second processing phase is performed on the new command. More specifically, the memory controller 112 determines whether the data required by such command is returned to the processor 102-108 which issued the command before internal processing for the command completes (e.g., in an attempt to optimize performance). This may occur when data required by such command is returned to the processor which issued the command before such data is written to a cache entry. Allowing the new command to access such cache entry before the previous command completes internal processing may not maintain memory/cache ordering. For example, data may be returned to a processor, which issued a first command, before a castout of data from cache caused by the processor is complete. The castout may be employed to make room for the data (e.g., fill data) in a cache entry. However, a second command (e.g., a subsequent command) may cause a cache-to-cache transfer (e.g., an intervention or HitM) that updates the cache entry before the first entry completes by writing the fill data to the cache entry. Therefore, the fill data may overwrite the data written to the cache entry during the cache-to-cache transfer caused by the second command, thereby disrupting memory/cache ordering.

The memory controller 112 includes logic 118 for storing one or more bits associated with each pending previously-received command for indicating whether data required by the command was returned to the processor 102-108 which issued the command before internal processing for the command completed. In one embodiment, the memory controller 112 stores a first bit (e.g., IsIDSwoL4MemWrite) indicating (e.g., when asserted) that data required by a command was returned to the processor issuing the command but such data was not yet written to the memory (e.g., cache) and a second bit (e.g., IsIDSwoAllSCPResp) indicating (e.g., when asserted) that data required by a command was returned to a processor issuing the command before all responses to a broadcast over a scalability network are received (e.g., and a cache entry is updated). Alternatively, the first bit may indicate that data required by a command was returned to the processor issuing the command but such data was not yet written to the memory when deasserted and/or the second bit may indicate that data required by a command was returned to a processor issuing the command before all responses to a broadcast over a scalability network are received when deasserted.

The second bit may be employed by apparatus for processing commands that include apparatus coupled via a scalability network, such as the apparatus 300 for processing commands. If either bit associated with any pending previously-received commands, which are stored in the memory controller storage area (e.g., queue) and require access to the same memory location (e.g., cache entry) required for processing the new command received in the memory controller 112, is asserted (e.g., set), the memory controller 112 may determine such command should complete before the second processing phase is performed on the new command. Alternatively, if neither bit associated with any pending previously-received commands, which are stored in the memory controller storage area (e.g., queue) and require access to the same memory location (e.g., cache entry) required for processing the new command received in the memory controller 112, is asserted (e.g., set), the memory controller 112 may determine such command should not (e.g., is not required to) complete before the second processing phase is performed on the new command.

Additionally, based on the above determination, the queue may send a signal, PQ_Q_NoChanceStall, to a processor bus interface (which is included in logic 118 of the memory controller) 112 for indicating whether a delay (e.g., stall) is required for maintaining memory ordering. If asserted, the signal, PQ_Q_NoChanceStall, indicates there are no pending commands previously received in the memory controller that should complete before the second phase of processing is performed on the new command. Alternatively, if deasserted, the signal, PQ_Q_NoChanceStall, indicates there are pending commands previously received in the memory controller 112 that should complete before the second phase of processing is performed on the new command. In some embodiments, PQ_Q_NoChanceStall may be asserted to indicate there are pending commands previously received in the memory controller 112 that should complete before the second phase of processing is performed on the new command and deasserted to indicate there are no pending commands previously received in the memory controller that should complete before the second phase of processing is performed on the new command.

If in step 408, it is determined there are not any pending commands previously received in the memory controller that should complete before the second phase of processing is performed on the new command, step 410 is performed. In step 410, the second phase of bus command processing is performed on the new command without requiring the memory controller to insert a processing delay on the bus. More specifically, the results of processing that started before the second phase, such as the memory controller tasks, are presented. The memory controller tasks may be completed while performing (e.g., during) the second phase of bus command processing. In this manner, although memory controller tasks may not have completed before the second phase of bus command processing, command processing may proceed to the second phase without requiring the memory controller 112 to insert a processing delay (e.g., a stall of the snoop phase (snoop stall)) on the bus 110. Therefore, results of processing required by the second phase of command processing may be returned provided sooner than if the memory controller 112 inserted a delay on the bus 110.

Additionally, remaining phases of command processing, such as the third and fourth phase, may be performed subsequently. Thereafter, step 416 is performed. In step 416, the method 400 ends.

Alternatively, if, in step 408, it is determined there are pending commands previously received in the memory controller that should complete before the second phase of processing is performed on the new command, step 412 is performed. However, such a determination is infrequently made during command processing because there are rarely pending commands previously received in the memory controller 112 that should complete before the second phase of processing is performed on the new command. In step 412, one or more processing delays are inserted on the bus such that any pending commands previously received in the memory controller that should complete before the second phase of processing is performed on the new command complete. For example, the memory controller may insert a processing delay (e.g., stall) on the bus 110 that delays the start of the second phase of processing. More specifically, memory controller logic 118, which serves as a bus interface, inserts a processing delay on the bus 110. In one embodiment, the processing delay delays the start of the second phase of processing for two clock cycles (although the processing delay may delay the second phase for a larger or smaller number of clock cycles. In this manner, pending commands previously received in the memory controller 112 that should complete before the second phase of processing is performed on the new command are allowed to complete, thereby avoiding disruption of memory ordering. During the processing delay, the memory controller tasks may continue and complete (e.g., before the second phase). Therefore, the memory controller 112 may avoid having to insert additional processing delays on the bus 110. If the memory controller tasks do not complete during such processing delay, additional processing delays may be inserted. In this manner, one or more processing delays may be inserted such that memory controller tasks, the results of which are required by the second phase of bus command processing, complete.

Thereafter, step 414 is performed. In step 414, the second phase of processing is performed on the new command. During the second phase of processing, the results of processing, such as the memory controller tasks, that completed before the second phase are presented.

Thereafter, step 416 is performed. As stated, in step 416, the method 400 ends.

Through use of the present methods and apparatus, an overall number of and/or frequency with which delays (e.g., stalls) are inserted by a memory controller 112 on a bus 110 during command processing may be reduced, thereby reducing command processing latency, and consequently, increasing system performance. More specifically, the present methods and apparatus reduce the number of delays inserted by the memory controller 112 on the bus 110 before the second (e.g., snoop phase) of command processing, and therefore, reduce the delay for subsequent command processing phases as well. The present methods and apparatus employ a heuristic (e.g., step 408 of method 400) that may be completed before the start of the second phase of command processing (e.g., in the time allotted from the start of the first phase to the start of the second phase of command processing).

The foregoing description discloses only exemplary embodiments of the invention. Modifications of the above disclosed apparatus and methods which fall within the scope of the invention will be readily apparent to those of ordinary skill in the art. For instance, in embodiments above, two scenarios in which data required by a command is returned to the processor 102-108 which issued the command before internal processing for the command completes (e.g., in an attempt to optimize performance) and bits corresponding to such scenarios are described, in other embodiments, a larger or smaller number of scenarios in which data required by a command is returned to the processor 102-108 which issued the command before internal processing for the command completes (e.g., in an attempt to optimize performance) may exist and bits corresponding to such scenarios may be employed.

Accordingly, while the present invention has been disclosed in connection with exemplary embodiments thereof, it should be understood that other embodiments may fall within the spirit and scope of the invention, as defined by the following claims.

The invention claimed is:

1. A method of processing commands on a bus, comprising:
in a first phase of bus command processing, receiving a new command from a processor in a memory controller via the bus, wherein a command on the bus is processed in a plurality of sequential phases;
starting to perform memory controller tasks the results of which are required by a second phase of bus command processing;
before performing the second phase of bus command processing on the new command, determining whether there are any pending commands previously received in the memory controller that should complete before the second phase of processing is performed on the new command; and
if there are no pending commands previously received in the memory controller that should complete before the second phase of processing is performed on the new command, performing the second phase of processing on the new command without requiring the memory controller to insert a processing delay on the bus.

2. The method of claim 1 further comprising completing the memory controller tasks the results of which are required by the second phase of processing while performing the second phase of processing on the new command without requiring the memory controller to insert a processing delay on the bus.

3. The method of claim 1 further comprising, if there are one or more pending commands previously received in the memory controller that should complete before the second phase of processing is performed on the new command:
inserting one or more processing delays on the bus such that any pending commands previously received in the memory controller that should complete before the second phase of processing is performed on the new command complete; and
performing the second phase of processing on the new command.

4. The method of claim 1 wherein the second phase is a snoop phase.

5. The method of claim 1 wherein determining whether there are any pending commands previously received in the memory controller that should complete before the second phase of processing is performed on the new command includes:
determining whether the new command requires access to the same memory address as any pending commands stored in the memory controller; and
if the new command requires access to the same memory address as one or more pending commands stored in the memory controller, determining whether such pending commands should complete before the second phase of processing is performed on the new command.

6. The method of claim 5 wherein determining whether such pending commands should complete before the second phase of processing is performed on the new command includes determining whether such pending commands should complete before the second phase of processing is performed on the new command to maintain proper memory ordering.

7. The method of claim 5 wherein determining whether such pending commands should complete before the second phase of processing is performed on the new command includes determining whether a bit corresponding to such a pending command is set, wherein the bit indicates the command should complete before the second phase of processing is performed on the new command.

8. The method of claim 1 wherein, if there are no pending commands previously received in the memory controller that should complete before the second phase of processing is performed on the new command, asserting a signal indicating no processing delay is required.

9. The method of claim 3 wherein:
inserting one or more processing delays on the bus such that any pending commands previously received in the memory controller that should complete before the second phase of processing is performed on the new command complete includes inserting one or more processing delays on the bus such that any pending commands previously received in the memory controller that should complete before the second phase of processing is performed on the new command complete and memory controller tasks the results of which are required by the second phase of processing complete; and
further comprising completing the memory controller tasks the results of which are required by the second phase of processing.

10. The method of claim 3 further comprising, if there are one or more pending commands previously received in the memory controller that should complete before the second phase of processing is performed on the new command, deasserting a signal indicating no processing delay is required.

11. An apparatus for processing commands on a bus, comprising:
a plurality of processors for issuing commands;
a memory;
a memory controller, coupled to the memory, for providing memory access to a command; and
a bus, coupled to the plurality of processors and memory controller, for processing the command;
wherein the apparatus is adapted to:
in a first phase of bus command processing, receive a new command from a processor in the memory controller via the bus, wherein a command on the bus is processed in a plurality of sequential phases;
start to perform memory controller tasks the results of which are required by a second phase of bus command processing;
before performing the second phase of bus command processing on the new command, determine whether there are any pending commands previously received in the memory controller that should complete before the second phase of processing is performed on the new command; and
if there are no pending commands previously received in the memory controller that should complete before the second phase of processing is performed on the new command, perform the second phase of processing on the new command without requiring the memory controller to insert a processing delay on the bus.

12. The apparatus of claim 11 wherein the apparatus is further adapted to complete the memory controller tasks the results of which are required by the second phase of processing while performing the second phase of processing on the new command without requiring the memory controller to insert a processing delay on the bus.

13. The apparatus of claim 11 wherein the apparatus is further adapted to, if there are one or more pending commands previously received in the memory controller that should complete before the second phase of processing is performed on the new command:
insert one or more processing delays on the bus such that any pending commands previously received in the memory controller that should complete before the second phase of processing is performed on the new command complete; and
perform the second phase of processing on the new command.

14. The apparatus of claim 11 wherein the second phase is a snoop phase.

15. The apparatus of claim 11 wherein the apparatus is further adapted to:
determine whether the new command requires access to the same memory address as any pending commands stored in the memory controller; and
if the new command requires access to the same memory address as one or more pending commands stored in the memory controller, determine whether such pending commands should complete before the second phase of processing is performed on the new command.

16. The apparatus of claim 15 wherein the apparatus is further adapted to determine whether such pending commands should complete before the second phase of processing is performed on the new command to maintain proper memory ordering.

17. The apparatus of claim 15 wherein the apparatus is further adapted to determine whether a bit corresponding to such a pending command is set, wherein the bit indicates the command should complete before the second phase of processing is performed on the new command.

18. The apparatus of claim 11 wherein the apparatus is further adapted to, if there are no pending commands previously received in the memory controller that should complete before the second phase of processing is performed on the new command, assert a signal indicating no processing delay is required.

19. The apparatus of claim 13 wherein the apparatus is further adapted to:
insert one or more processing delays on the bus such that any pending commands previously received in the memory controller that should complete before the second phase of processing is performed on the new command complete and memory controller tasks the results of which are required by the second phase of processing complete; and
complete the memory controller tasks the results of which are required by the second phase of processing.

20. The apparatus of claim 13 wherein the apparatus is further adapted to, if there are one or more pending commands previously received in the memory controller that should complete before the second phase of processing is performed on the new command, deassert a signal indicating no processing delay is required.
